(19) United States
(12) Patent Application Publication
(10) Pub. No.: US 2020/0065513 A1
(43) Pub. Date: Feb. 27, 2020

(54) CONTROLLING CONTENT AND CONTENT SOURCES ACCORDING TO SITUATIONAL CONTEXT

(71) Applicant: International Business Machines Corporation, Armonk, NY (US)

(72) Inventors: Srihari Sridharan, Nairobi (KE); Komminist Weldemariam, Ottawa (CA); Abdigani Diriye, Nairobi (KE); Solomon Assefa, Ossining, NY (US)

(21) Appl. No.: 16/112,083

(22) Filed: Aug. 24, 2018

(51) Int. Cl. G06F 21/62; G06N 99/00

(52) U.S. Cl. CPC G06F 21/6245; G06F 21/629; G06N 99/005

(57) ABSTRACT

A user situational context and user's computing device context is detected based on input data. Content associated with the user's computing device and an importance factor associated with the content is determined. A risk factor associated with disclosing the content is determined based on the importance factor. A controlling action is triggered to control the content.

### BACKGROUND

The present application relates generally to computers and computer applications, and more particularly to controlling content on a computing device.

Some techniques allow for hiding or controlling content on a computing device, particularly for content considered to carry sensitive information. For example, when a smartphone or like device is in lock-down mode or by specifying on user settings, a user can control displaying and not displaying of sensitive notification content, which may be transmitted via electronic mail (email), short message service (SMS), social media app, or others. However, such control mechanism only hides the content, but not the source of the content. As another example, content may be edited to automatically remove sensitive information based on a predefined policy stored in persistent memory by monitoring user interaction with a computer peripheral for a criterion. However, such mechanisms do not consider situational awareness of the user and computing devices.

### BRIEF SUMMARY

A computer-implemented method and system may be provided. The method, in one aspect, may include receiving input data comprising sensor data observed by one or more sensors coupled with a user's computing device. The method may also include detecting a user situational context based on at least some of the input data. The method may further include detecting the user's computing device context based on at least some of the input data. The method may also include determining content associated with the user's computing device and an importance factor associated with the content. The method may further include determining a risk factor associated with disclosing the content based on the importance factor. The method may also include triggering a controlling action to control the content and/or content sources.

A system, in one aspect, may include at least one hardware processor coupled with a network interface and a memory device coupled with the at least one hardware processor. The at least one hardware processor may be operable to at least receive input data comprising sensor data observed by one or more sensors coupled with a user's computing device. The at least one hardware processor may be further operable to detect a user situational context based on at least some of the input data. The at least one hardware processor may be further operable to detect the user's computing device context based on at least some of the input data. The at least one hardware processor may be further operable to determine content associated with the user's computing device and an importance factor associated with the content. The at least one hardware processor may be further operable to determine a risk factor associated with disclosing the content based on the importance factor. The at least one hardware processor may be further operable to trigger a controlling action to control the content and/or content sources.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a flow diagram illustrating a method in one embodiment.

FIG. 2 is a diagram showing components of a system in one embodiment.

FIG. 3 is an example diagram of a neural network model which classifies or outputs actions to be performed in one embodiment.

FIG. 4 illustrates a data processing, classification and result phases of a system of the present disclosure in one embodiment.

FIG. 5 is a diagram showing components of a system in one embodiment that controls content on a computing device based on situational context.

FIG. 6 illustrates a schematic of an example computer or processing system that may implement a system according to one embodiment.

### DETAILED DESCRIPTION

A method, system and techniques may be provided, which predict and/or detect a user computing device's situational context (and, for example, the user's situational context), and automatically control content on the computing device and/or sources of content according to predicted situational context. Controlled content, for example, may include incoming confidential or sensitive data such as email and other incoming notifications. Sources of such content, for example, may include an email application, server or system, calendar application, server or system, a social network and/or media application, server or system, text messaging application, server or system, chat messaging application, server or system, video, imaging and/or other multimedia application, server or system, and/or others which may send content to the computing device.

Controlling content and content sources based on, for example, situational awareness of the user and computing devices is useful. For example, such control is helpful in a situation where an individual is forced to open and unwillingly show the content on the computing devices. A user may also lend the user's computing device such as a mobile phone, laptop, or another device, for a short duration of time to a family member, a colleague, or even to a stranger temporarily. In other examples, a computing device can be stolen, a user can be away from the user's computing devices for temporary period. During any of those periods, the computing device may receive sensitive content, for example, via email, SMS, chat application, and/or others, and the user may likely want to protect such content from being disclosed to others. The present disclosure in some aspects addresses the problem of when and how to intelligently determine the need for controlling content and content sources and act accordingly, for example, in opt-in or opt-out manner.

Examples of a user computing device may include a smartphone, tablet computer, laptop computer, desktop computer, and/or others. In some embodiments, content and/or content sources may be controlled by performing one or more of actions. An action may include any one or more of the following: deleting an email; asking for a password every time content is accessed on the device, for example, asking for application password such as email password, social network or media application password; removing pictures from the device and pushing it to cloud; encrypting important content based on risk factor of content from content analyzer; transferring content to a secondary computing device; stopping synchronizing of device content and content sources and/or applications with remote content sources and/or applications; hiding content arrival (e.g., disabling showing notifications); transferring content to another content format (e.g., by blurring image, deducing quality of the content).

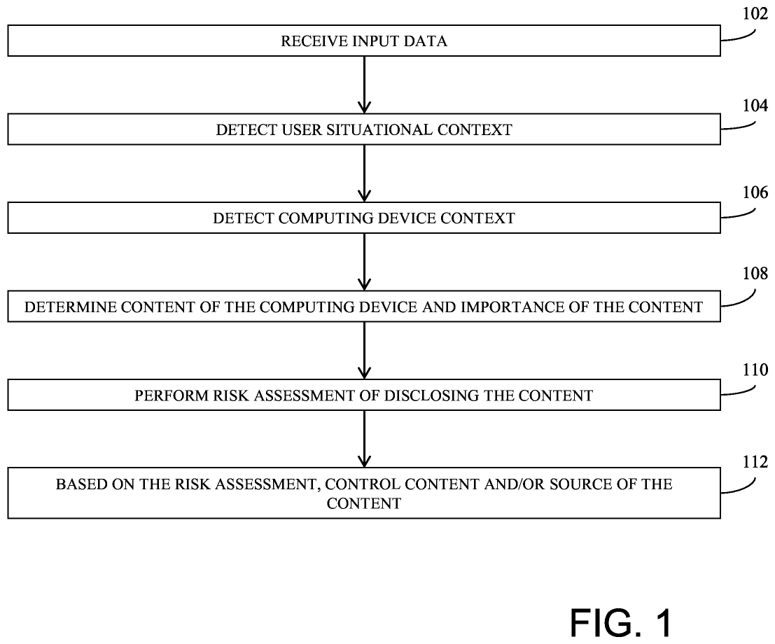

FIG. 1 is a flow diagram illustrating a method in one embodiment. The method may run on the user computing device, a remote server device (e.g., a device on a cloud computing environment or another computing environment such as in an organization's computer system), or both on a user device and a remote device wherein the user device and remote device communicate accordingly to exchange data, information and analytical models. One or more hardware processors may execute the method. For example, a processor may be a central processing unit (CPU), a graphics processing unit (GPU), a field programmable gate array (FPGA), an application specific integrated circuit (ASIC), another suitable processing component or device, or one or more combinations thereof. The processor may be coupled with a memory device. The memory device may include random access memory (RAM), read-only memory (ROM) or another memory device, and may store data and/or processor instructions for implementing various functionalities associated with the methods and/or systems described herein. The processor may execute computer instructions stored in the memory or received from another computer device or medium.

At 102, input data is received. Input data may include sensor data, signals from one or more beacons (e.g., a smartphone may be able to receive such signals once a beacon is in range), signals from wifi gateways, data associated with user apps (applications) deployed or running on user device, secondary data sources such as crowd-sourced location data.

At 104, a user situational context is detected, for example, based on the input data. Detecting or determining the user situational context, for example, may include predicting that a user carrying a computing device (also referred to as a primary computing device or primary device) is approaching a risky location at particular time of the day based on geo-location profile analysis; sensing that a user is unwillingly asked to open the computing device, for example, based on voice/speech recognition and/or crowd density/crowd sensing techniques that run on the user device; sensing that a user is away from the computing device for a duration D time period using user activity monitoring (e.g., touch-based and/or visual analytics). The method may detect situational context of the user and the user's n computing device further by analyzing data received from a plurality of data sources such as a mobile device's built-in sensor (e.g., global positioning system (GPS), accelerometer, camera, microphone, and/or another), crowd-sourced location information, data received from a nearby computing device (e.g., a nearby mobile device) and/or communication device (e.g., wifi gateways, beacon, network devices, and/or another) and capture information, e.g., via camera, microphone, and historical incident reports. For instance, a beacon signal may indicate a location of the user. Global positioning system (GPS) data and motion sensor data may indicate the user approaching a location of the user.

At 106, context of the computing device (also referred to as a computing device context) is detected or determined. The computing device context, for example, includes whether the computing device is in a secondary user's possession (e.g., held by a secondary user), for example, for a temporary duration period (D). It may be determined that the computing device may be stolen. In one embodiment, whether a user computing device is under another user's control can be detected from information obtained from one or more sensors or peripheral devices coupled with the computing device such as a motion sensor, touch sensor, camera, microphone, and/or another. For example, using touch sensor data, user interaction pattern with the computing device can be determined. In another example, visual analytics may be performed by taking or capturing front camera information and performing face recognition and/or micro-expression based analytics. Yet as another example, voice recognition may be performed based on speech information obtained via a microphone coupled with the computing device. In one aspect, whether a threshold duration for the determined risk or concern is valid may be determined based on information such as a location profile (current location of the computing device), the other user's behavior, past interaction data of the other user with the user primary user devices. In one embodiment, a depth perception device may be used to estimate the intent of an on-coming user, for example, another user approaching the computing device.

At 108, content of the computing device may be determined and importance of the content may be determined. For example, different content associated with the computing device may be determined or inferred based on the types of apps deployed on the computing device. For example, it may be determined that the computing device receives emails by detecting an email app on the computing device; it may be determined that the computing device receives text or multi-media messages based on a text app, chat app, social network app, and/or the like. Other information may allow inferring types of content that the computing device stores or receives. Content may include on-device content and incoming content, for example, email content, message data from social network and/or media app, messaging app, chat app, and/or others. Content may also include images, video, and/or other multi-media content stored or received on the computing device. Computing the importance of the content (also referred to as an importance level or importance factor) may include analyzing content metadata, message of the content, source of the content, historical data, and/or other information. In some embodiments, user profile (e.g., user role such as manager, senior manager) data is further used to determine the importance level of the content.

At 110, risk assessment may be performed of disclosing the content based on the importance level of the content, for example, computed or determined at 108. In one aspect, user information may be also considered, such the user's role. For example, a computer-implemented risk assessment module may determine the risk of disclosing content to another user based on the computed importance level of the content and a user profile (e.g., user role such as a manager, lawyer, law enforcement officer, business owners). Such information may be detected from the user profile using mobile data, social media profile, or other data. The risk factor may be determined further based on a location profile comprising previous incidents history associated with the location.

At 112, based on the risk assessment, for example, the content on the computing device and/or the source of the content is controlled or triggered to be controlled. In one aspect, the controlling of the content and/or sources, for example, is done according to a specific user situational context and computing device context. Controlling, for example, includes performing to triggering a controlling action associated with the content and/or the source of the content. Examples of a controlling action may include but are not limited to: deleting the emails, asking for a password every instance the content is accessed on the computing device, removing images or photos from the computing device (and pushing or saving to another system such as a cloud computing environment), encrypting important content based on a risk factor of the content (e.g., determined from performing the risk assessment), auto-transferring the content to a secondary computing device, stopping synchronizing of on-device content and content sources (e.g., apps) with remote content sources (e.g., apps), auto-hiding the content arrivals (e.g., disabling showing notifications), auto-transferring the content to another content formats (e.g., by blurring image, deducing quality of the content, and/or another).

For example, if the risk level is determined which is above a threshold (e.g., predefined or configured threshold level), a computer-implemented action generation is automatically triggered. As an example, the computer-implemented action generation may load an action template from a device-based or cloud-based database. An action template may include instructions to stop the device's email client from synchronizing confidential email, auto-delete (automatically delete) sensitive email or content, transfer sensitive content to a secondary computing devices, or the like.

In another aspect, policies or rules may be maintained and managed. A user may supply such policies or rules. For each content type, specific policies or rules can be defined or specified. In another aspect, over time, the specific policies or rules associated with content type can be learned from historical data. A controlling action may be automatically selected based on the policies and/or rules and the current situational context of the user and the computing device, and the content. For instance, a policy or rule may specify to perform an action given a specific situational context of the user and the computing device, and the content. The current situational context of the user and the computing device, and the content may be matched with a policy or rule to determine an action to trigger or perform in order to control the content and/or the source of the content. In one aspect, policies and/or rules may be learned automatically based on historical data.

In one aspect, an action to be triggered to control the content and/or the source of the content may be selected and/or prioritized based on confidence scores computed by a machine learning algorithm or trained machine learning model such as a trained neural network model. In one aspect, the content and/or content source controlling policies and/or rules can be represented as multidimensional array, wherein each dimension of the array may represent one aspect of the content or content source concern. Such representation may provide for optimally storing and retrieving the policies or rules in a memory or storage device. In one aspect, the policies or rules may be adjusted over time, for example, new policies or rules added, existing policies or rules removed, existing policies or rules updated. The adjusting of the policies or rules may be done automatically by a hardware processor. For instance, a machine learning module may interactively query, track, and learn from user new patterns of interaction and/or engagement and from a plurality of information sources and other new data points, to update the policies and/or rules.

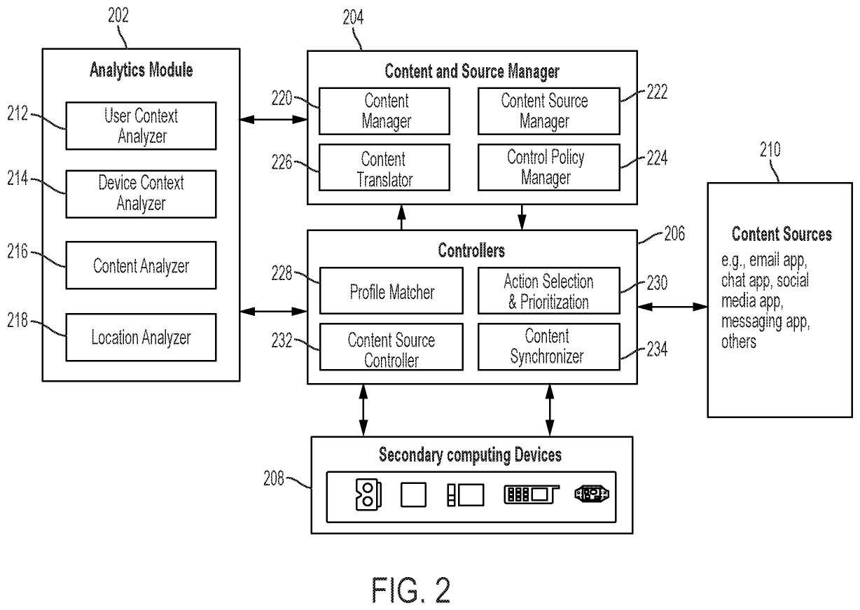

FIG. 2 is a diagram showing components of a system in one embodiment. One or more of the components can be software programs or modules running on a hardware processor or programmed on a hardware processor. The system components may include an analytics module 202, which for example, may include functions or modules such as a user context analyzer 212, device context analyzer 214, content analyzer 216 and location analyzer 218.

As an example, the user context analyzer 212 may determine user's current situational context. The module may also learn user's concerns by analyzing information obtained from the user's social network or social media application or server, analyzing historical user engagements, and/or others.

A device context analyzer 214 determines the device context, for example, whether the device is in possession by another, for example, based on sensor data.

A content analyzer 216 may determine content on the user computing device. For example, the content analyzer 216 may evaluate the content being displayed on the device, for example, a message, video, photo, and/or other information being presented on the device. Based on specific keywords and message sources, the content analyzer 216 can identify the importance, sensitivity, and/or confidentiality of the message.

A location analyzer 218 maps the locations where the device has been and the durations at the locations to build a model of typical user behavior. In one aspect, this model is used in evaluating the situational context of a user at a specific location determined by the location analyzer 218, for example, by the user context analyzer 212. The location analyzer 218 also profiles a location with one or more properties such as crowd-density at a given time, incidents, time of the day, and/or other information.

In one aspect, the user context analyzer 212, the device context analyzer 214, the content analyzer 216 and the location analyzer 218 have a number of preconfigured policies and/or rules to identify situational contexts that require the trigger of manipulation actions such as password protection or closing and disabling an app. In one aspect, each component may leverage a variety of supervised, unsupervised and rule-based techniques to identify user behavior and determine the action to take.

For example, the status of the device can be tagged as being in a specific location at a specific time (e.g., between 9 am-5 pm, Monday-Friday). An example tag with such information may be tagged with a label, e.g., at Office. Such information can identify typical or normal user behavior. The device context analyzer 214 may use data about an application from its product description, data associated with user interactions with the application, and content associated with the application to classify the application. For example, the device context analyzer 214 may identify an X email application as a work application, Y email application as a non-work application, Z chat application as a casual conversation application, and/or others. The device context analyzer 214 may track and build a model of user behavior that reflects the user's typical or routine day-to-day activities. This information can be stored under the user profile. For example, the device context analyzer 214 may consider a user checking an email at a specific time in the morning and calling a car service to take the user to the office as a user's typical weekday activity. Deviance from this activity can signal a change in the user's situational context.

In one aspect, the content analyzer 216 may use a natural language processing (NLP) technique to identify specific actions and names from the content in applications running on the user computing device (e.g., a smartphone). Based on a dictionary of keywords or the like, the content analyzer 216 may identify and/or tag content as being a highly sensitive message. The analytics module 202 may combine output from the constituting modules 212, 214, 216, 218 to use the identified user context, device context, content and location to determine the situational context of the user and take the necessary actions to protect the user and sensitive data.

In one aspect, an optimization may be performed to further determine and characterize a location profile. For example, a user can walk down the street with mixed neighborhoods with the computing device. One would be wasting a lot of computations on performing unnecessary set of actions when the user is a frequent visitor of the location (at a point of interest or point of service), which may not be very efficient. In this case, the method of triggering the content and content source controllers learns a hierarchy in set of actions based on thresholds prior to triggering or invoking the said controllers.

The system components may also include a content and source manager module 204, which may include functions or modules such as a content manager 220, a content source manager 222, a control policy manager 224 and a content translator 226. For instance, a content manager 220, which may be a computer-implemented dynamic content manager module, may compute an importance factor of the content (e.g., both on-device and incoming content) by analyzing one or more of content metadata, message of the content, source of the content, and metadata of the content. For each content, the content importance may be assigned based on one or more of the levels of confidentiality and sensitivity of the content. A content source manager 222 may maintain information about a plurality of content sources 210, which may provide content to the user computing device. Examples of content sources may include, but are not limited to, email app, messaging app, social media app, social network app, chat app, and/or others.

In one embodiment, a computer-implemented control policy manager module 224 may manage user supplied or learned policies or rules for controlling content and content sources. For each content type, specific policies or rules can be defined or specified. The policies and rules may be used by an action generation engine, module or functionality to automatically match policies or rules to a set of controlling actions. The matching, for example, is part of selecting an action based on a given policy or rule set among a possible set of actions generated by a trained neural network model.

In one embodiment, the controlling rules can be geo-tagged (e.g., at a service point and/or location) and configured to a computing device (e.g., a smartphone, intelligent personal assistant service device, a smart speaker), and/or to a communication device (e.g., Beacon, wifi hotspot, cellular tower). For instance, the control policy manager 224 may geo-tag the controlling rules and configure them to a computing device and/or to a communication device.

In one embodiment, content and content sources controlling policies and rules may be adjusted. For instance, new policies and rules may be accepted, policies and rules may be discarded, policies and rules may be updated, for example, tightened or relaxed over time, for example, using a computer-implemented custom active learning (e.g., semi-supervised machine learning) module, which may interactively query, track, and learn from user new patterns of interaction or engagement and from a plurality of information sources and other new data points.

In another embodiment, a computer-implemented content translator module 226 may translate the learned concerns (e.g., learned by an analytics module 202) into controlling rules. For each translated rule R, the module may further compute the degree of concern and assign weight to the rule R. In one embodiment, the content and/or content source controlling rules can be represented as multidimensional array, for example, optimally, wherein each dimension of the array may represent one aspect of the content or content source concern.

The system components may also include controllers 206, which may include functions or modules such as a profile matcher 228, an action selection and prioritization module 230, a content synchronizer 234 and a content source controller 232. In one embodiment, a set of candidate actions is identified associated with detected risk or concern level of the content and content sources in response to identified degree of concerns for content(s) and content source(s) of the user. The candidate actions may be controlled by computer-implemented module, e.g., controllers 206, which further reduces or prevents a content or content source from being accessed or disclosed to another user inappropriately. In one embodiment, triggering a preventive action may further consider the other user's context (e.g., whether the other user is a family member, a user cohort (e.g., an adult or under-aged)), and device context (e.g., shared device, work phone, and/or another context).

In one embodiment, the content source controller 232 takes actions from the action selection and prioritization module 230, and also content profile (e.g., content source metadata information) from a profile matcher module 228, and controls the source 210, for example, to redirect a notification or data to another device, suspend an incoming notification or data from the source. In one aspect, controlling the source 210 may include intercepting messages from the source 210 and hiding or redirecting the messages.

The profile matcher 228 may also extract the relevant profile associated with the user and settings to identify what content should be controlled. The action prioritization and selection module 230 generates actions such as delete mail, request password, remove data such as picture, video, and/or others, transfer to secondary device, encrypt message, and/or another action. This set of actions has a mapping to the different applications and content sources. For example, an application that has been identified to have image capturing capabilities may be mapped to actions such as blocking access to the camera or password protecting a pictures folder stored on user computing device. As another example, a messaging application may be associated with capabilities and a list of privileges required upon downloading the application (e.g., accessing contacts, wifi, or another on the computer device). The messaging application is then mapped to actions such as requesting a password to open the application, copying messages to a secondary device, and deleting messages. Content source controller 232, for example, may perform such controlling actions.

A content synchronizer 234 may ensure data such as sensitive data, password protected messages and data deleted from the primary device is transferred to a secondary device 208. In this way, information from the user computing device (primary device) is still retrievable or available, even in situations where the primary device is no longer accessible.

For example, one or more secondary computing devices 208 may store or save information, which may have been hidden, removed, or blocked from receiving from one or more content sources 210, as a result of a controlling action. For example, in one embodiment, the user computing device can be paired with a secondary user computing device 208 such as a smartwatch, a ring, or another, and using a probe signal between the two devices, the proximity of the user computing device (primary user device) from the secondary computing device can be determined. If the primary user device is under another user's control, the secondary user computing device 208 may trigger a computer-implemented content source controller module 232. In one aspect, the content source controller module 232 may execute from the user computing device locally. In another aspect, the content source controller module 232 may execute on a cloud computing environment or another remote computing environment.

In some embodiments, a computer-implemented optimization module may take into consideration the resource constrained nature of the computing device (e.g., device will be out of power in 10 minutes, interment internet connectivity or no internet) and selectively apply action(s) for content and content sources(s) deemed to be risky or of concern, e.g., for the user and/or an organization.

In one embodiment, a depth perception device may be used to estimate the intent of an on-coming user. Risky locations can be estimated to a degree based on safety rate index (e.g., respect to a specific safety concerns) of an area.

The status of the user computing device (e.g., plugged into a laptop, plugged into mains, running a messaging application, running on low battery) can further be determined by analyzing and aggregating outputs from various peripheral sensors.

In one aspect, the action selection and prioritization module 230 may use a custom machine learning algorithms. Given an action space A, and a state space (situation) S, a machine learning algorithm such as a neural network, can be used to estimate the confidence in the action(s) to be taken. The neural network model estimates parameters to choose a label (action). In one aspect, multiple labels (multi-class) can be estimated each with a confidence score. A set of actions having confidence score or scores above a threshold may be triggered to control content and/or a source of the content.

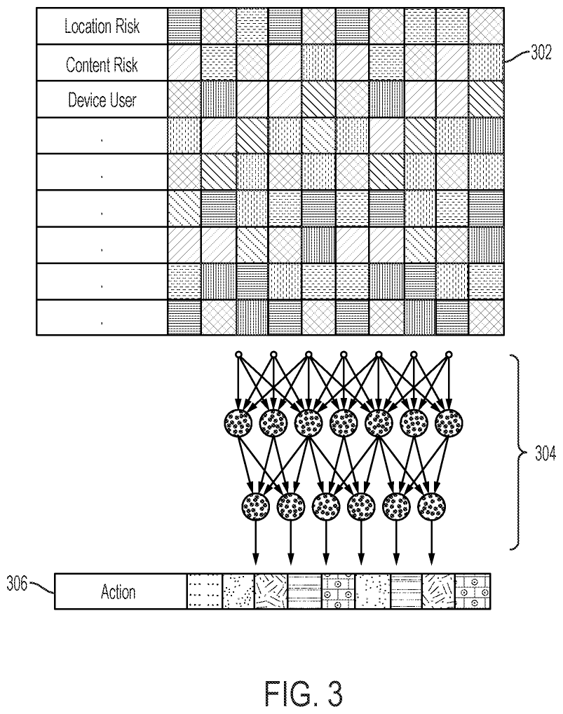

FIG. 3 is an example diagram of a neural network model which classifies or outputs actions to be performed in one embodiment. A neural network 304, for example, which is a fully connected network, may output or classify actions (e.g., provide confidence scores) 306 given a vector of features 302 as input representing the user situational context, device context and content. In one aspect, the neural network 304, for example, is trained based on historical data comprising labeled training data which include input (user situational context, device context and content) to output (actions) mappings. The neural network 304 may be retrained periodically based on additional training data set.

For instance, an action, “stop synchronizing”, may be output (classified with high confidence score) given a state space comprising {Device not in owner's hand, Content risk factor: Medium, Location: Unsecure, Surrounding threat level: Low, Connected to open network: Yes}. As another example, an action “automatic deleting” may be output (classified with high confidence score) given a state space comprising {Device not in owner's hand, Content risk factor: High (Classified), Location: Under physical threat}. In some embodiments, the neural network-based model shown in FIG. 3 generates a set of actions and then selects one or more actions that matches a given policy, e.g., “Stopping sync”.

In another aspect, a system of the present disclosure may predict a threshold duration for the determined risk or concern to be valid based on a location profile (location information), the other user behavior, past interaction data of the other user with the user's primary user devices.

Situational awareness can be instrumental in safeguarding content. For instance, a user is walking down the street in a neighborhood. In instances with heightened levels of insecurity, the system of the present disclosure can take precaution and trigger necessary steps to protect sensitive data. Input received to determine a situational awareness may include but is not limited to: location (e.g., a risk level of the location can be estimated based on safety rate, with respect to a safety index of an area); intent of on-coming actions (given movement of the phone, depth perception, the system can infer or determine the intent of on-coming actions, e.g. running, phone being tugged). Based on the situation awareness, one or more actions can be executed by the disclosed system.

The following describes predicting or detecting situational context of a user and user computing device, and recommending one or more actions to take in order to control content and a source of the content, for example, incoming confidential or sensitive email from an email application, incoming notification from a messaging application, social network/media application, and/or another, according to the predicted situational context. As an example, the system of the present disclosure may denote the set of actions that can be taken such as “delete email”, “stop synchronizing”, “password protect” as Set A={A1, A2, . . . , An}; the set of program, applications and/or content on the device as P={P1, P2, . . . , Pn}; function f to take in a vector V=<v1, v2, . . . , vn> representing the context (e.g., location, time of day, risk level, and/or others), programs (applications) and content on the device to recommend a ranked list of action A with an associated Relevance Score R>0 and R<1 of the action A. As an example, the value R denotes how important it is to take an action A. If a threshold t is surpassed multiple actions can be undertaken.

In one embodiment, the function f in one instantiation uses a Support Vector Machine (SVM) classifier that classifies the input data, an approach which involves reducing to a quadratic programming problem and maximum-margin hyperplane in a transformed feature space. The transformation may be nonlinear and the transformed space high dimensional.

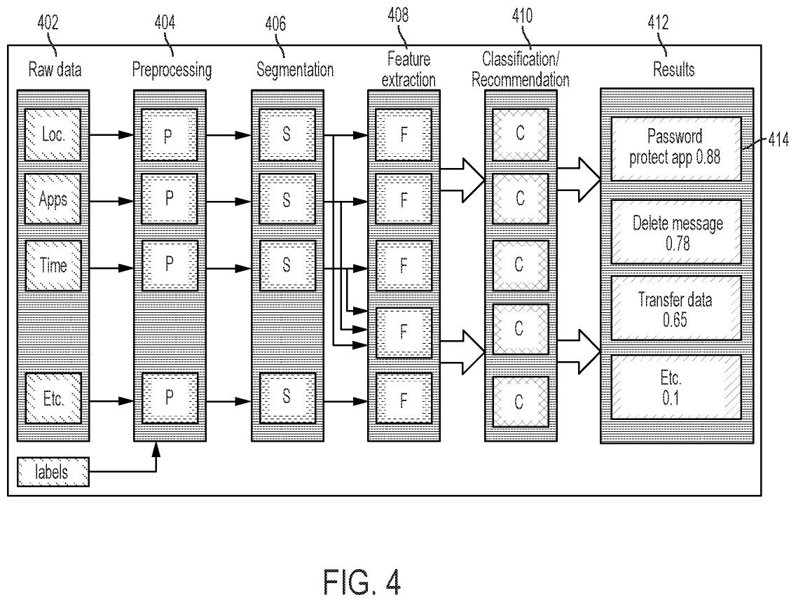

FIG. 4 illustrates a data processing, classification and result phases of a system of the present disclosure in one embodiment. FIG. 4 outlines an example of the different stages and data flow of a machine learning process in one embodiment. At 402, raw data, for example, data from a plurality of sources such as a location device, apps, temporal device, phone device, social media/network apps, and/or others are ingested. These data streams are then pre-processed at 404. Each data source has a series of pre-processing steps. For example, textual data from social media is processed through natural language processing (NLP) and text processing. These data sources are then labelled using user provided labels or historic data. The next phase at 406 entails a segmentation of this data based on the context or situation. Using this data, the next phase at 408 includes an extraction of features, for example, both existing and derived. The feature space is expanded, and a series of classification/recommendation algorithms are applied at 410, which then provides the actions and the value associated with it at 412. For example, the category for password protection 414 is rated at 0.88, which is the recommended action given the data compared to deleting the message or transfer the data.

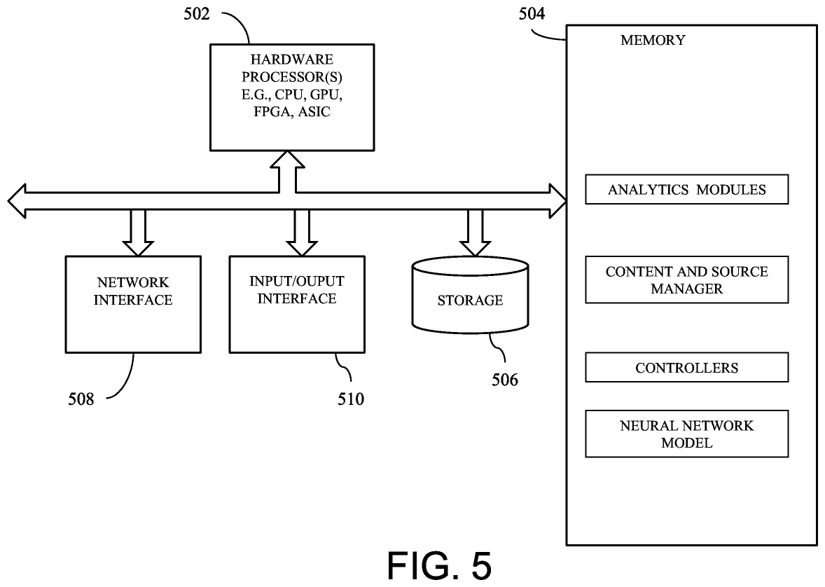

FIG. 5 is a diagram showing components of a system in one embodiment that controls content on a computing device based on situational context. One or more hardware processors 502 such as a central processing unit (CPU), a graphic process unit (GPU), and/or a Field Programmable Gate Array (FPGA), an application specific integrated circuit (ASIC), and/or another processor, may be coupled with a memory device 504, and generate a prediction model and recommend communication opportunities. The memory device may include random access memory (RAM), read-only memory (ROM) or another memory device, and may store data and/or processor instructions for implementing various functionalities associated with the methods and/or systems described herein. The processor may execute computer instructions stored in the memory or received from another computer device or medium. The memory device 504 may, for example, store instructions and/or data for functioning of the one or more hardware processors 502, and may include an operating system and other program of instructions and/or data. One or more hardware processors 502 may receive input, for example, comprising sensor data observed by one or more sensors coupled with a user's computing device. For instance, at least one hardware processor 502 may detect a user situational context based on at least some of the input data, detect the user's computing device context based on at least some of the input data, determine content associated with the user's computing device and an importance factor associated with the content, determine a risk factor associated with disclosing the content based on the importance factor, triggering a controlling action to control the content. In one aspect, one or more of input data may be stored in a storage device 506 or received via a network interface 508 from a remote device, and may be temporarily loaded into the memory device 504 for triggering a controlling action to control content on a computing device. Detected situational context of the user and the user's computing device, and information about content may be also stored in a storage device 506. A machine learning model such as a neural network may be also loaded on memory 504, for example, and run to determine one or more controlling actions given a set of feature vectors representing a current situational context. The one or more hardware processors 502 may be coupled with interface devices such as a network interface 508 for communicating with remote systems, for example, via a network, and an input/output interface 510 for communicating with input and/or output devices such as a keyboard, mouse, display, and/or others.

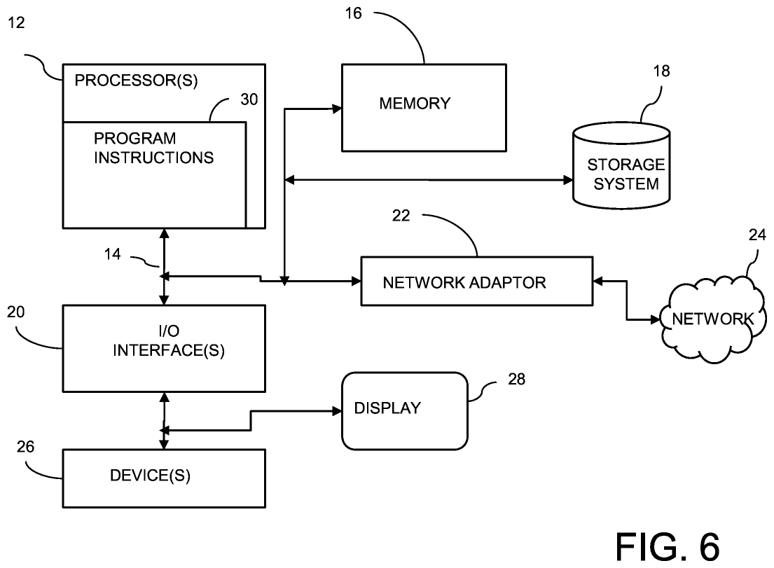

FIG. 6 illustrates a schematic of an example computer or processing system that may implement a system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 6 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A computer-implemented method comprising:
receiving input data comprising sensor data observed by one or more sensors coupled with a user's computing device;
detecting a user situational context based on at least some of the input data;
detecting the user's computing device context based on at least some of the input data;
determining content associated with the user's computing device and an importance factor associated with the content;
determining a risk factor associated with disclosing the content based on the importance factor; and
triggering a controlling action to control the content.

2. The method of claim 1, wherein the user's computing device comprises a smartphone.

3. The method of claim 1, wherein the input data further comprises at least one of: signals received repeatedly from a beacon device, signals from a wifi gateway, crowed-sourced location data, and information associated with an application deployed on the user's computing device.

4. The method of claim 1, wherein the risk factor is determined further based on a user profile comprising a role of the user and a location profile comprising previous incidents history associated with the location.

5. The method of claim 1, wherein the content comprises content stored on the user's computing device and an incoming content from one or more content sources.

6. The method of claim 1, wherein the controlling action further comprises controlling a source of the content.

7. The method of claim 1, wherein the controlling action comprises at least one of:
stopping data from being sent to the user's computing device;
removing the content from the user's computing device;
stopping of synchronizing of an app on the user's computing device with an app on a remote device;
sending the content to a secondary device to storage;
asking for a password every time the content is accessed on the user's computing device;
disabling presentation of a notification associated with the content on the user's computing device; and
transforming the content to a different format.

8. The method of claim 1, further comprising running a machine learning model that classifies controlling actions given an input vector associated with the user situational context, and the user's computing device context, and a type of the content.

9. The method of claim 1, wherein a plurality of policies are defined associated with controlling content, and the controlling action to control the content is selected based on the plurality of policies.

10. The method of claim 9, wherein the plurality of policies are updated based on a machine learning model.

11. A computer readable storage medium storing a program of instructions executable by a machine to perform a method comprising:
receiving input data comprising sensor data observed by one or more sensors coupled with a user's computing device;
detecting a user situational context based on at least some of the input data;
detecting the user's computing device context based on at least some of the input data;
determining content associated with the user's computing device and an importance factor associated with the content;
determining a risk factor associated with disclosing the content based on the importance factor; and
triggering a controlling action to control the content.

12. The computer readable storage medium of claim 11, wherein the user's computing device comprises a smartphone.

13. The computer readable storage medium of claim 11, wherein the input data further comprises at least one of: signals received repeatedly from a beacon device, signals from a wifi gateway, crowed-sourced location data, and information associated with an application deployed on the user's computing device.

14. The computer readable storage medium of claim 11, wherein the risk factor is determined further based on a user profile comprising a role of the user.

15. The computer readable storage medium of claim 11, wherein the content comprises content stored on the user's computing device and an incoming content.

16. The computer readable storage medium of claim 11, wherein the controlling action further comprises controlling a source of the content.

17. The computer readable storage medium of claim 11, wherein the controlling action comprises at least one of:
stopping data from being sent to the user's computing device;
removing the content from the user's computing device;
stopping of synchronizing of an app on the user's computing device with an app on a remote device;
sending the content to a secondary device to storage;
asking for a password every time the content is accessed on the user's computing device;
disabling presentation of a notification associated with the content on the user's computing device; and
transforming the content to a different format.

18. The computer readable storage medium of claim 11, further comprising running a machine learning model that classifies controlling actions given an input vector associated with the user situational context, and the user's computing device context, and a type of the content.

19. The computer readable storage medium of claim 11, wherein a plurality of policies are defined associated with controlling content, and the controlling action to control the content is selected based on the plurality of policies.

20. A system comprising:
at least one hardware processor coupled with a network interface; and
a memory device coupled with the at least one hardware processor,
the at least one hardware processor operable to at least:
receive input data comprising sensor data observed by one or more sensors coupled with a user's computing device;
detect a user situational context based on at least some of the input data;
detect the user's computing device context based on at least some of the input data;
determine content associated with the user's computing device and an importance factor associated with the content;
determine a risk factor associated with disclosing the content based on the importance factor; and
trigger a controlling action to control the content.
